(19) United States
(12) Patent Application Publication
(10) Pub. No.: US 2017/0314749 A1
(43) Pub. Date: Nov. 2, 2017

(54) UNIVERSAL MOUNTING FRAME ASSEMBLY FOR AN OPTICAL ASSEMBLY

(71) Applicant: Focal Point, LLC, Chicago, IL (US)

(72) Inventors: Ken Czech, Naperville, IL (US); Scott Pahl, Lisle, IL (US); Josue Moctezuma, Lake Beach, IL (US); Zach Payne, Chicago, IL (US); Edwin Vice, JR., Chicago, IL (US)

(21) Appl. No.: 15/143,067

(22) Filed: Apr. 29, 2016

(51) Int. Cl. F21S 8/02; F21V 17/00; F21V 29/70; F21V 7/00; F21V 17/12; F21V 17/10

(52) U.S. Cl. CPC F21S 8/026; F21V 17/12; F21V 17/101; F21V 29/70; F21V 7/00; F21V 17/002

(57) ABSTRACT

Aspects of this disclosure relate to a mounting frame assembly for use with coupling to an optical assembly, the mounting frame assembly may comprise: a mounting frame comprising a first attachment interface spaced apart from a second attachment interface, wherein the mounting frame is configured to support a junction box; an aperture plate, coupled to the mounting frame at the first and second attachment interfaces, the aperture plate comprising a first aperture configured to receive a reflector assembly; and a first mounting bracket adjustably-coupled to the first attachment interface, and a second mounting bracket adjustably-coupled to the second attachment interface, the first and second mounting brackets configured to provide adjustable coupling of the mounting frame to a ceiling structure between at least two positions along a vertical direction.

### BACKGROUND

A universal mounting frame assembly for an optical assembly may comprise elements configured to accommodate both circular and square optical assemblies. For example, different shapes and sizes of luminaires and reflectors may be designed to accommodate a specific size and shape of optical assembly containing a specific configuration of one or more light sources. Accordingly, a universal mounting frame assembly for an optical assembly is required to accommodate each of a square and circular optical assembly.

### BRIEF SUMMARY

According to one aspect, a luminaire may comprise: a mounting frame comprising a first attachment interface spaced apart from a second attachment interface; an aperture plate, coupled to the mounting frame at the first and second attachment interfaces, the aperture plate comprising a first aperture configured to receive a reflector assembly; a first mounting bracket adjustably-coupled to the first attachment interface, and a second mounting bracket adjustably-coupled to the second attachment interface, the first and second mounting brackets configured to provide adjustable coupling of the mounting frame to a ceiling structure between at least two positions along a vertical direction; and an optical assembly removably-coupled to the mounting frame, comprising at least one light source configured to emit light through the first aperture.

According to another aspect, a mounting frame assembly for use with coupling to an optical assembly, the mounting frame assembly may comprise: a mounting frame comprising a first attachment interface spaced apart from a second attachment interface, wherein the mounting frame is configured to support a junction box; an aperture plate, coupled to the mounting frame at the first and second attachment interfaces, the aperture plate comprising a first aperture configured to receive a reflector assembly; and a first mounting bracket adjustably-coupled to the first attachment interface, and a second mounting bracket adjustably-coupled to the second attachment interface, the first and second mounting brackets configured to provide adjustable coupling of the mounting frame to a ceiling structure between at least two positions along a vertical direction.

According to yet another aspect, a mounting frame assembly for use with coupling to an optical assembly, the mounting frame assembly may comprise: a mounting frame comprising a first attachment interface spaced apart from a second attachment interface, wherein the mounting frame is configured to support a junction box; an aperture plate, coupled to the mounting frame at the first and second attachment interfaces, the aperture plate comprising a first aperture configured to receive a reflector assembly, wherein the aperture plate is interchangeable with the mounting frame between a round aperture plate for a round optical assembly and a square aperture plate for a square optical assembly; and a mounting surface to couple a junction box to the mounting frame, wherein the mounting surface includes at least two lance tabs that are received in at least two slots located at a bottom of the junction box, and further wherein the at least two lance tabs include an angled portion that flexes and compresses upon insertion of the lance tabs into the slots and then expands when the lance tab is fully inserted into the slots, thereby preventing the junction box from being decoupled from the mounting surface without compressing the lance tabs.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and not limited in the accompanying figures in which like reference numerals indicate similar elements and in which:

FIG. 1 depicts an isometric view of an example luminaire, according to one or more aspects described herein.

FIG. 2A depicts a front view of the example luminaire of FIG. 1, according to one or more aspects described herein.

FIG. 2B depicts a side view of the example luminaire of FIG. 1, according to one or more aspects described herein.

FIG. 3A depicts an isometric view of a mounting frame assembly, according to one or more aspects described herein.

FIG. 3B depicts an isometric view of the mounting frame assembly of FIG. 3A with a junction box, according to one or more aspects described herein.

FIG. 3C depicts an isometric view of another mounting frame assembly, according to one or more aspects described herein.

FIG. 3D depicts an isometric view of the mounting frame assembly of FIG. 3C with a junction box, according to one or more aspects described herein.

FIG. 4 depicts a bottom view of a portion of the mounting frame assembly of FIG. 3A, according to one or more aspects described herein.

FIG. 5 depicts an isometric view of a portion of another mounting frame, according to one or more aspects described herein.

Further, it is to be understood that the drawings may represent the scale of different components of one single embodiment; however, the disclosed embodiments are not limited to that particular scale.

### DETAILED DESCRIPTION

Aspects of this disclosure relate to a mounting frame assembly for use with coupling to an optical assembly, the mounting frame assembly may comprise: a mounting frame comprising a first attachment interface spaced apart from a second attachment interface, wherein the mounting frame is configured to support a junction box; an aperture plate, coupled to the mounting frame at the first and second attachment interfaces, the aperture plate comprising a first aperture configured to receive a reflector assembly; and a first mounting bracket adjustably-coupled to the first attachment interface, and a second mounting bracket adjustably-coupled to the second attachment interface, the first and second mounting brackets configured to provide adjustable coupling of the mounting frame to a ceiling structure between at least two positions along a vertical direction. Additionally, the mounting frame assembly may include a mounting surface to couple a junction box to the mounting frame, wherein a bottom of the junction box includes at least two lance tabs that are received in at least two slots located at the mounting surface, and further wherein the at least two lance tabs include an angled portion that flexes and compresses upon insertion of the lance tabs into the slots and then expands when the lance tab is fully inserted into the slots, thereby preventing the junction box from being decoupled from the mounting surface without compressing the lance tabs.

In the following description of the various embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made without departing from the scope and spirit of the present disclosure.

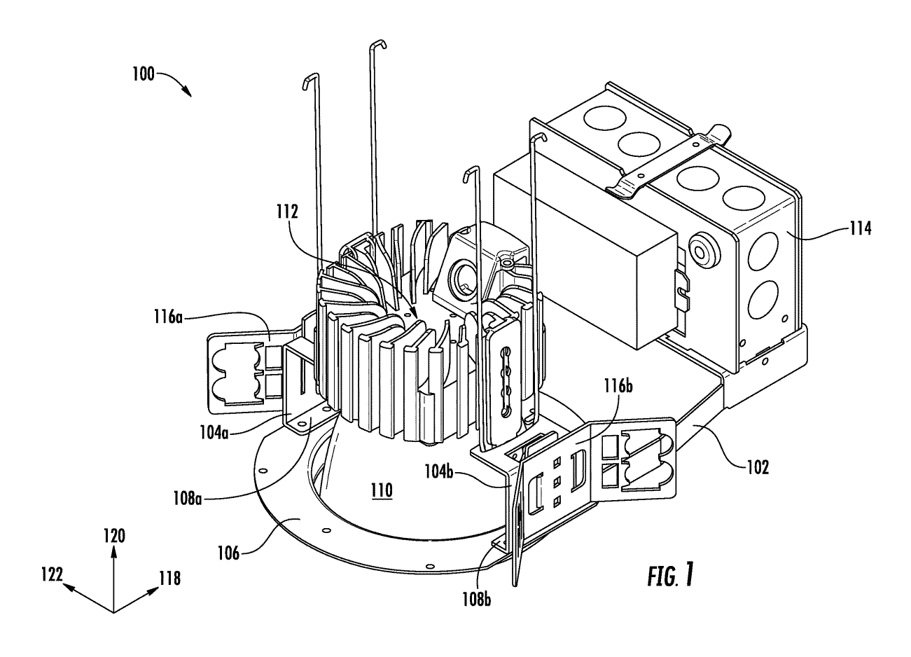

FIG. 1 depicts an isometric view of an example luminaire 100, according to one or more aspects described herein. The luminaire 100 may comprise a mounting frame or a mounting frame assembly 102 with a first mounting surface 108a and a second mounting surface 108b. The luminaire 100 may further comprise an aperture plate 106 that is coupled to the mounting frame assembly 102 at the first and second mounting surfaces 108a and 108b. As will be discussed, the aperture plate may be either circular or square. As such, a coupling between the aperture plate 106 and the first and second mounting surfaces 108a and 108b may utilize one or more fasteners (not pictured in FIG. 1), including, among others, one or more screws, bolts, nuts, welding, or rivets. The optical assembly may be removably-coupled to the mounting frame assembly 102. In turn, the reflector 110 may be slidably engaged with, and removably-coupled to, a light engine assembly 112. The light engine assembly 112, in turn, may be configured with a heat sink to provide a surface area from which heat energy generated by one or more light sources (not pictured FIG. 1) within the luminaire 100 may be dissipated.

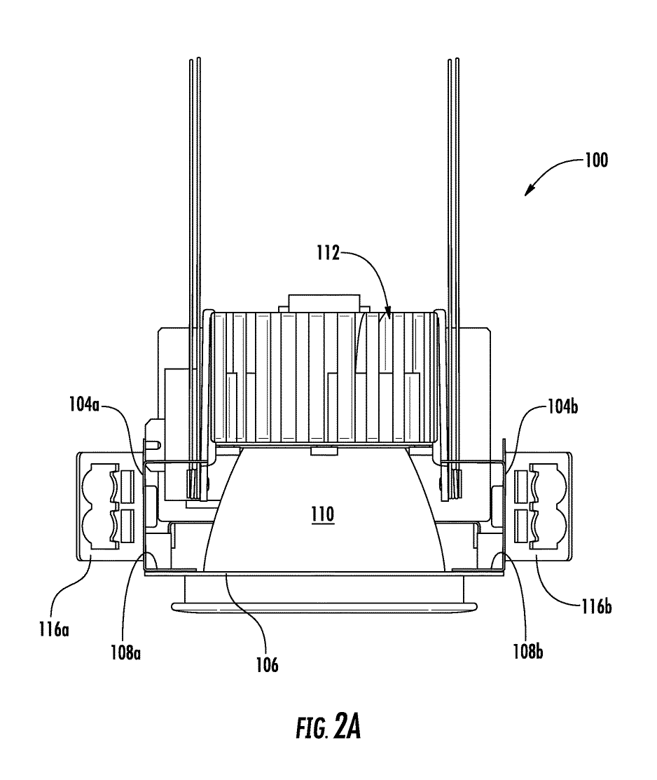

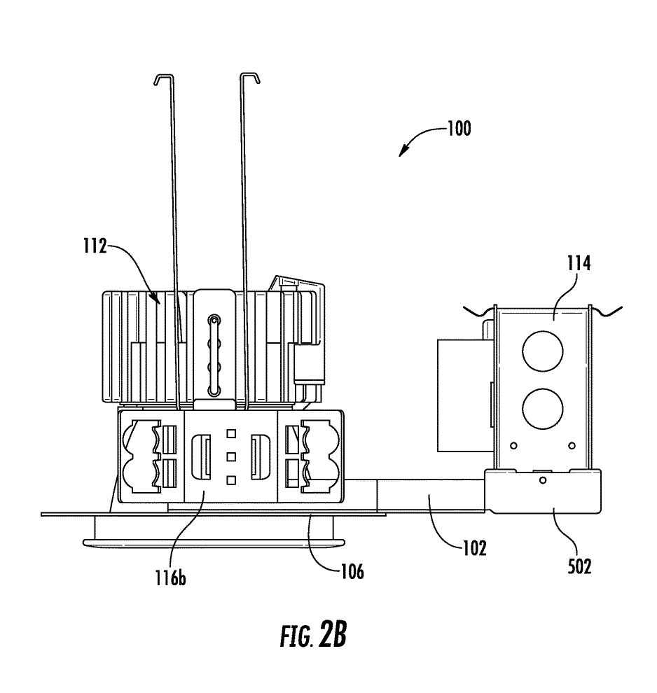

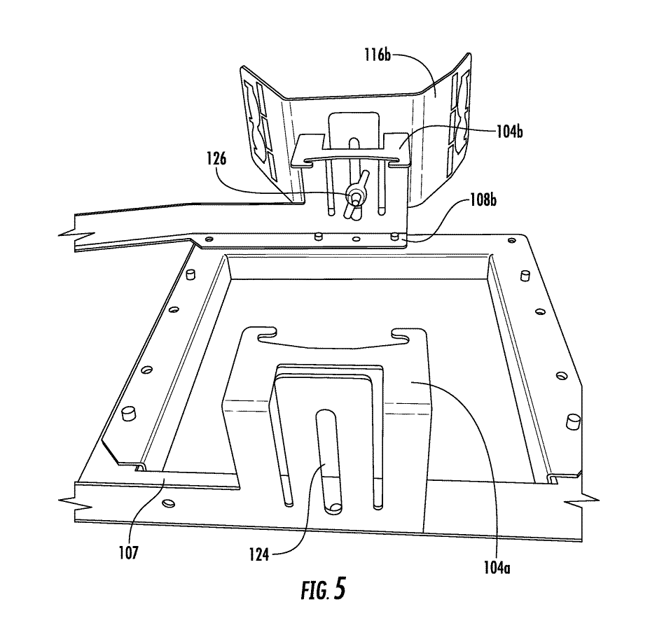

The mounting frame assembly 102 may be configured to be coupled to an external support structure (not pictured in FIG. 1). In one example, the mounting frame assembly 102 may be adjustably-coupled to a ceiling structure (not pictured in FIG. 1), and such that a plane defined by those directions 118 and 122 represents a substantially horizontal plane. In particular, a first mounting bracket 116a may be utilized to adjustably-couple the first attachment interface 104a to an external structure (e.g. a ceiling structure) and a second mounting bracket 116b may be utilized to adjustably-couple the second attachment interface 104b to the external structure (e.g. ceiling structure). In one example, the mounting brackets 116a, 116b may provide adjustable coupling of the mounting frame assembly 102 to a ceiling structure (not pictured in FIG. 1) between at least two positions along that direction associated with arrow 120. As illustrated in FIG. 1, the mounting brackets 116a, 116b may provide adjustable coupling between three positions based on the three locking holes 124 (or a slot 124 as illustrated in FIG. 5) for the mounting brackets 116a, 116b. A securing fastener or screw (not shown) may be utilized to lock the mounting brackets 116a, 116b with the three locking holes. FIGS. 2A and 2B depict different views of the example luminaire 100, according to one or more aspects described herein. In particular, FIG. 2A depicts a front view of the luminaire 100 and FIG. 2B depicts a side view of the luminaire 100.

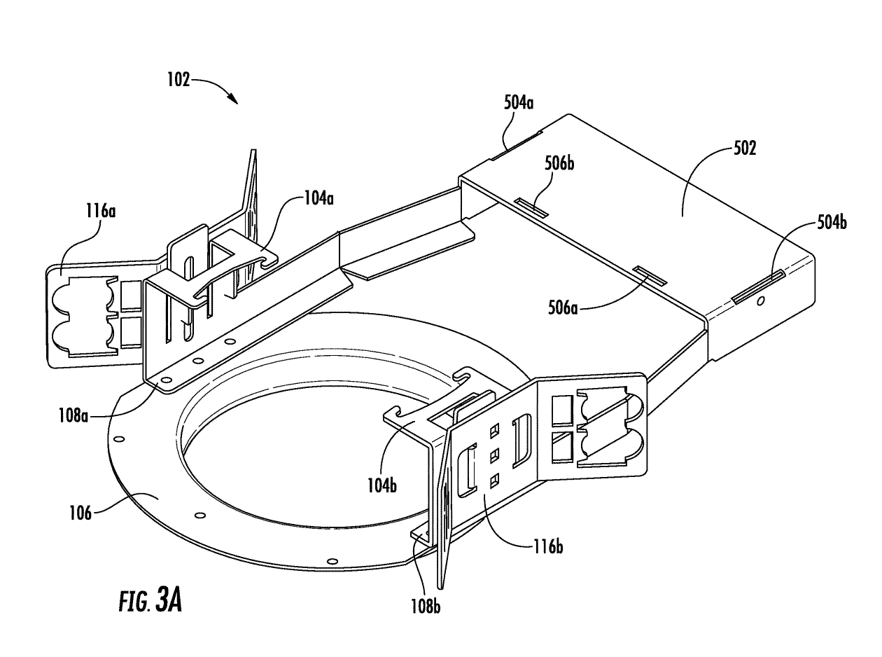

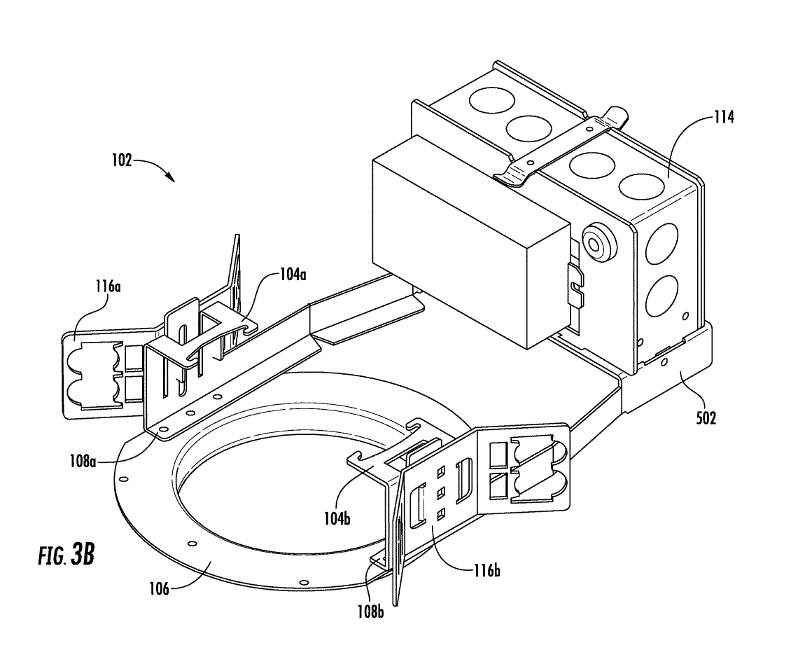

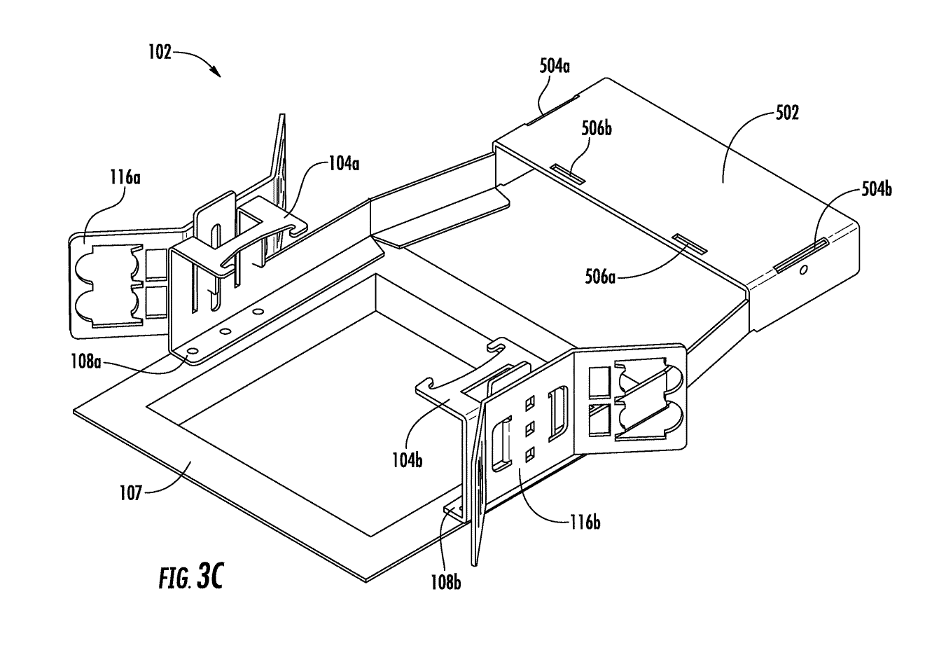

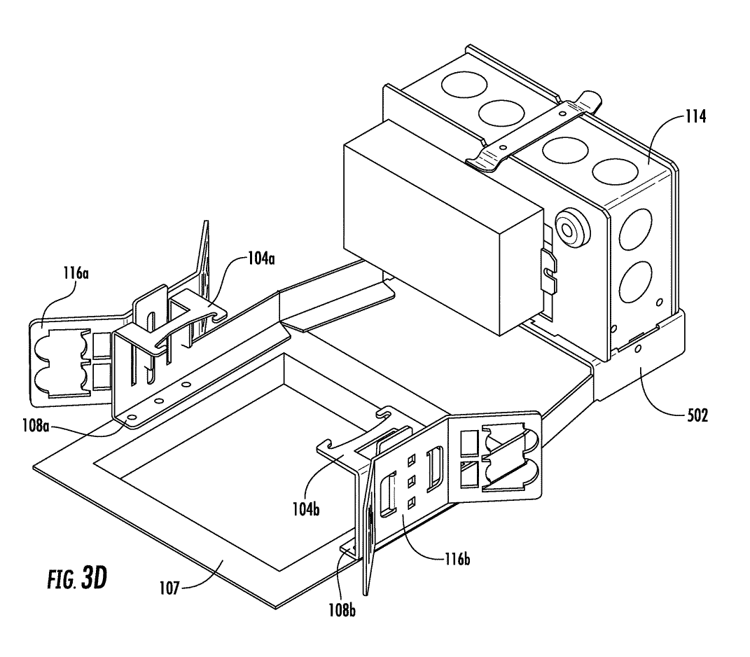

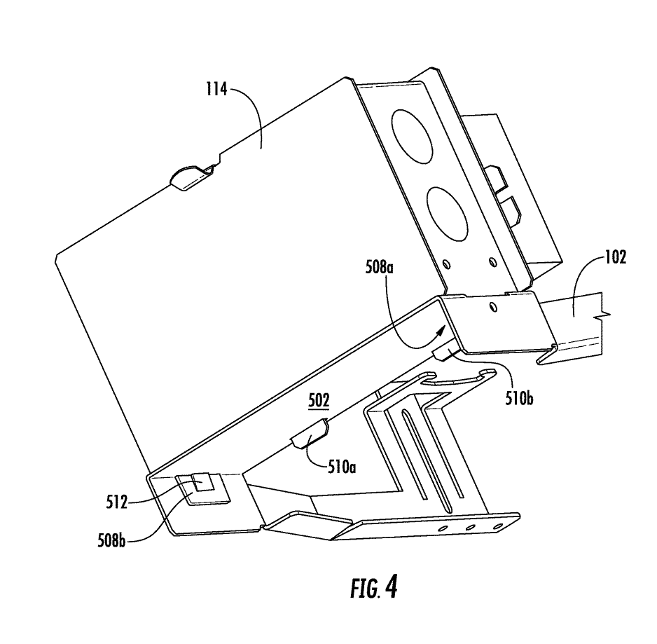

FIG. 3A depicts an isometric view of the mounting frame assembly 102 slidably coupled to mounting brackets 116a, 116b with a circular aperture plate 106. The mounting frame assembly 102 of FIG. 3A includes a round aperture plate 106. The mounting brackets 116a, 116b may be configured to move relative to the mounting frame assembly 102 along that direction 120 such that a height of the mounting frame assembly 102 may be adjusted when coupled to an external ceiling structure, and the like. The mounting frame assembly 102 may comprise a mounting surface 502 onto which a junction box 114 (not pictured in FIG. 3A) may be coupled. The mounting surface 502 may further comprise slots 504a, 504b configured to couple the junction box 114, as depicted in FIGS. 3B, 3D, and 4. FIGS. 3C and 3D depict isometric views of the mounting frame assembly 102 slidably coupled to mounting brackets 116a, 116b with a square aperture plate 107. The mounting frame assembly 102 may be configured with a round aperture plate 106 or the square aperture plate 107 which allows the mounting frame assembly 102 to be utilized for a round optical assembly or a square optical assembly.

FIG. 4 depicts a bottom view of a portion of the mounting frame assembly 102. Accordingly, as depicted FIG. 4, the junction box 114 may be coupled to the mounting surface 502 of the mounting frame assembly 102 by two lance tabs 508a, 508b located on the junction box 114 that are received into the slots 504a, 504b located on the mounting surface 502, respectively. In this way, an angled portion 512 of the lance tab 508b may flex and compress upon insertion of the lance tab 508b into the slot 504b, and may expand when the lance tab 508b is fully inserted into the slot 504b, thereby preventing the junction box 114 from being decoupled from the mounting surface 502 without compressing the angled portion 512 of the lance tabs 508a, 508b. Therefore, the junction box 114 is coupled to the mounting surface 502 of the mounting frame assembly 102 without utilizing any fasteners.

FIG. 5 illustrates an isometric view of a mounting frame assembly 102. In one example, the mounting brackets 116a, 116b may provide adjustable coupling of the mounting frame assembly 102 to a ceiling structure (not pictured in FIG. 5) between an unlimited number of positions along that direction associated with arrow 120. As illustrated in FIG. 5, the first attachment interface 104a and the second attachment interface 104b may include a slot 124. The mounting brackets 116a, 116b may provide adjustable coupling between an unlimited number of positions with the slot 124 for the mounting brackets 116, 116b. A securing fastener or screw 126 may be utilized to lock the mounting brackets 116a, 116b with slot 124.

In the foregoing, reference is made to the various elements as having one or more of a “top,” “bottom,” “front,” “back,” “left,” and/or “right” side, and/or a “horizontal,” or “vertical” orientation. However, these terms are merely associated with one example orientation used to aid in the description of the various elements of this disclosure. As such, the disclosed implementations in the foregoing are not limited to any one orientation. Similarly, the various elements described throughout this disclosure may be scaled in proportion to one another, such that the various implementations described herein may have any dimensional values. In another example, one or more elements described in this disclosure may be scaled disproportionately, and such that the accompanying Figures may not represent true proportions of the various elements described herein.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

We claim:

1. A luminaire, comprising:
a mounting frame assembly comprising a first attachment interface spaced apart from a second attachment interface;
an aperture plate, coupled to the mounting frame assembly at the first and second attachment interfaces, the aperture plate comprising a first aperture configured to receive a reflector assembly;
a first mounting bracket adjustably-coupled to the first attachment interface, and a second mounting bracket adjustably-coupled to the second attachment interface, the first and second mounting brackets configured to provide adjustable coupling of the mounting frame assembly to a ceiling structure between at least two positions along a vertical direction; and
an optical assembly removably-coupled to the mounting frame assembly, comprising at least one light source configured to emit light through the first aperture.

2. The luminaire of claim 1, wherein the aperture plate is a circular aperture plate utilized for a round optical assembly.

3. The luminaire of claim 1, wherein the aperture plate is a square aperture plate utilized for a square optical assembly.

4. The luminaire of claim 1, wherein the mounting frame assembly is configured to support a junction box.

5. The luminaire of claim 1, further comprising a mounting frame to couple a junction box to the mounting frame assembly.

6. The luminaire of claim 5, wherein a bottom of the junction box includes at least two lance tabs that are received in at least two slots located on the mounting frame.

7. The luminaire of claim 6, wherein the at least two lance tabs include an angled portion that flexes and compresses upon insertion of the lance tabs into the slots and then expands when the lance tab is fully inserted into the slots, thereby preventing the junction box from being decoupled from the mounting frame without compressing the lance tabs.

8. The luminaire of claim 5, wherein the junction box includes tabs that are configured to be received in a plurality of locating slots located on the mounting frame.

9. A mounting frame assembly for use with coupling to an optical assembly, the mounting frame assembly comprising:
a mounting frame comprising a first attachment interface spaced apart from a second attachment interface, wherein the mounting frame is configured to support a junction box;
an aperture plate, coupled to the mounting frame at the first and second attachment interfaces, the aperture plate comprising a first aperture configured to receive a reflector assembly; and
a first mounting bracket adjustably-coupled to the first attachment interface, and a second mounting bracket adjustably-coupled to the second attachment interface, the first and second mounting brackets configured to provide adjustable coupling of the mounting frame to a ceiling structure between at least two positions along a vertical direction.

10. The mounting frame assembly of claim 9, wherein the aperture plate is a circular aperture plate utilized for a round optical assembly.

11. The mounting frame assembly of claim 9, wherein the aperture plate is a square aperture plate utilized for a square optical assembly.

12. The mounting frame assembly of claim 9, further comprising a mounting surface to couple a junction box to the mounting frame.

13. The mounting frame assembly of claim 12, wherein the mounting surface includes at least two lance tabs that are received in at least two slots located at a bottom of the junction box.

14. The mounting frame assembly of claim 13, wherein the at least two lance tabs include an angled portion that flexes and compresses upon insertion of the lance tabs into the slots and then expands when the lance tab is fully inserted into the slots, thereby preventing the junction box from being decoupled from the mounting surface without compressing the lance tabs.

15. The mounting frame assembly of claim 12, wherein the junction box includes tabs that are configured to be received in a plurality of locating slots located on the mounting surface.

16. A mounting frame assembly for use with coupling to an optical assembly, the mounting frame assembly comprising:
a mounting frame comprising a first attachment interface spaced apart from a second attachment interface, wherein the mounting frame is configured to support a junction box;
an aperture plate, coupled to the mounting frame at the first and second attachment interfaces, the aperture plate comprising a first aperture configured to receive a reflector assembly, wherein the aperture plate is interchangeable with the mounting frame between a round aperture plate for a round optical assembly and a square aperture plate for a square optical assembly; and
a mounting surface to couple a junction box to the mounting frame, wherein the mounting surface includes at least two lance tabs that are received in at least two slots located at a bottom of the junction box, and further wherein the at least two lance tabs include an angled portion that flexes and compresses upon insertion of the lance tabs into the slots and then expands when the lance tab is fully inserted into the slots, thereby preventing the junction box from being decoupled from the mounting surface without compressing the lance tabs.

17. The mounting frame assembly of claim 16, further comprising a first mounting bracket adjustably-coupled to the first attachment interface, and a second mounting bracket adjustably-coupled to the second attachment interface, the first and second mounting brackets configured to provide adjustable coupling of the mounting frame to a ceiling structure between at least two positions along a vertical direction.

18. The mounting frame assembly of claim 16, wherein the junction box includes tabs that are configured to be received in a plurality of locating slots located on the mounting surface.
